(19) United States
(12) Patent Application Publication
(10) Pub. No.: US 2014/0045564 A1
(43) Pub. Date: Feb. 13, 2014

(54) ANTI-CHEATING METHOD AND SYSTEM FOR ONLINE GAMES

(71) Applicant: TENCENT TECHNOLOGY (SHENZEN) COMPANY LIMITED, Shenzhen (CN)

(72) Inventors: BIJIAN GUO, Shenzhen (CN); JIANG LIN, Shenzhen (CN); QING LI, Shenzhen (CN)

(73) Assignee: TENCENT TECHNOLOGY (SHENZEN) COMPANY LIMITED, Shenzen (CN)

(21) Appl. No.: 14/011,776

(22) Filed: Aug. 28, 2013

Related U.S. Application Data
(63) Continuation of application No. PCT/CN2013/080080, filed on Jul. 25, 2013.

(30) Foreign Application Priority Data
Aug. 7, 2012 (CN) 201210277957.1

(51) Int. Cl. A63F 13/00

(52) U.S. Cl. CPC A63F 13/00
USPC 463/2

(57) ABSTRACT

An anti-cheating method for online games between a server and a client is provided. The server receives launch parameters of a projectile from the client, wherein the launch parameters are determined based on user operation commands obtained by the client. The server calculates a trajectory of the projectile based on the launch parameters. The server sends the trajectory of the projectile to the client such that the client shows launch of the projectile based on the trajectory of the projectile.

### CROSS-REFERENCES TO RELATED APPLICATIONS

This application is a continuation of PCT Patent Application No. PCT/CN2013/080080, filed on Jul. 25, 2013, which claims priority of Chinese Patent Application No. 201210277957.1, filed on Aug. 7, 2012, the entire contents of all of which are incorporated by reference herein.

### FIELD OF THE INVENTION

The present invention generally relates to computer technologies and, more particularly, to an anti-cheating method and system for online games.

### BACKGROUND

Electronic game refers to video game that employs electronics (e.g., computer, game device, etc.) to create an interactive system with which a player can play.

With the rapid development of computer technology and networking technology, the Internet is playing an increasingly important role in our daily life, study and work. Multiplayer gaming platform provides multiple players with online gaming services on Internet, such that users may play games easily through the Internet, just like playing games on a local area network (LAN). Through network protocol conversion technology, the multiplayer gaming platform closely connects players from far away geographical locations, and also provides real-time information exchanges and communications.

Any games based on LAN can be played on the multiplayer gaming platform through local area network, without the need for a dedicated server or for remembering complicated IP addresses. Therefore, the player can play games with other players more conveniently. In every room of the multiplayer gaming platform, all players can play games with others just like through the local area network. The players can interact with each other through the local area network, and communicate with others at any time, enjoying the fun of playing games.

A plug-in (or plugin) is a cheating program that modifies design and structure of one or more online games to give one player an advantage over others.

The calculation of ballistic trajectory of a projectile is often involved in online games. With existing technology, the ballistic trajectory is usually calculated in the client. If there are multiple clients, each client individually calculates the ballistic trajectory. Then, the client sends calculation result to the server. After the server checks the calculation result and calculates damage, the server sends back the result to the client. However, in this method, because the trajectory is calculated in the client, the algorithm may be easily cracked by the plug-in; and incorrect ballistic trajectory information is sent to the server by packet data or offline hanging, etc. Thus, one player may obtain advantages over other players when playing the game. The balance of the game is affected, making the game lose its fair feature and interfering with the normal order of the game.

The disclosed method and apparatus are directed to solve one or more problems set forth above and other problems.

### BRIEF SUMMARY OF THE DISCLOSURE

One aspect of the present disclosure includes an anti-cheating method for online games between a server and a client. The server receives launch parameters of a projectile from the client, wherein the launch parameters are determined based on user operation commands obtained by the client. The server calculates a trajectory of the projectile based on the launch parameters. The server sends the trajectory of the projectile to the client such that the client shows launch of the projectile based on the trajectory of the projectile.

Another aspect of the present disclosure includes an anti-cheating system for online games between a server and a client. The client is configured to obtain user operation commands and determine launch parameters of the projectile based on the user operation commands. The client is also configured to send the launch parameters to the server and show the launch of the projectile based on a trajectory of the projectile. The server is configured to calculate the trajectory of the projectile based on the launch parameters and send the trajectory of the projectile to the client.

Other aspects of the present disclosure can be understood by those skilled in the art in light of the description, the claims, and the drawings of the present disclosure.

### BRIEF DESCRIPTION OF THE DRAWINGS

The exemplary embodiments of the present invention are described in detail by referring to the accompanying drawings, such that those skilled in the art can understand the features and advantages of the present invention. In the accompanying drawings:

FIG. 1 illustrates a flow diagram of an exemplary anti-cheating method for online games consistent with the disclosed embodiments;

FIG. 2 illustrates a schematic diagram of an exemplary online game map that is divided into numerous terrain squares consistent with the disclosed embodiments;

FIG. 3 illustrates a data storage diagram of an exemplary online game map consistent with the disclosed embodiments;

FIG. 4 illustrates a data storage diagram of an exemplary hole map of a projectile consistent with the disclosed embodiments;

FIG. 5 illustrates a schematic diagram of an exemplary AND operation for terrain data and hole map data of a projectile consistent with the disclosed embodiments.

FIG. 6 illustrates a schematic diagram of an exemplary AND operation result for terrain data and hole map data of a projectile consistent with the disclosed embodiments;

FIG. 7 illustrates a schematic diagram of an exemplary OR operation for terrain data and hole map data of a projectile consistent with the disclosed embodiments;

FIG. 8 illustrates a schematic diagram of an exemplary OR operation result for terrain data and hole map data of a projectile consistent with the disclosed embodiments;

FIG. 9 illustrates an exemplary gaming system for online games consistent with the disclosed embodiments; and

FIG. 10 illustrates a block diagram of an exemplary computer system capable of implementing client and/or server.

### DETAILED DESCRIPTION

Reference will now be made in detail to exemplary embodiments of the invention, which are illustrated in the accompanying drawings.

For a turn-based war game, based on the specific operations of the player, a client determines launch parameters of a projectile including launch angle of the projectile, launch force of the projectile, initial launch velocity of the projectile, and sends the launch parameters to a server. The server calculates ballistic trajectory, the destruction and damage of the terrain based on the received launch parameters, and sends the calculation results to the client. Then, the client shows a specific picture presentation based on the received ballistic trajectory, the destruction and damage of the terrain. Thus, the server performs key logical operations and sends the operation results to the client. The client only shows the results rather than performs the key logical operations. Therefore, plug-in is prevented, further improving the fair feature of the game.

FIG. 9 illustrates an exemplary game system 900 incorporating certain disclosed embodiments. As shown in FIG. 9, game system 900 may include a client 901 and a server 902. The client 901 may access the server 902 through the Internet for certain gaming services provided by the server 902. Although only one server 902 and one client 901 is shown in the game system 900, any number of clients 901 or servers 902 may be included, and other devices may also be included.

The Internet (not labeled) may include any appropriate type of communication network for providing network connections to client 901 and server 902 or among multiple clients 901 and servers 902. For example, Internet may include the Internet or other types of computer networks or telecommunication networks, either wired or wireless.

A client, as used herein, may refer to any appropriate user client with certain computing capabilities, such as a personal computer (PC), a work station computer, a server computer, a hand-held computing device (tablet), a smart phone or mobile phone, or any other user-side computing device. In certain embodiments, client 901 may be a wireless client, such as a smart phone, a tablet computer, or a mobile phone, etc.

A server, as used herein, may refer to one or more server computers configured to provide certain web server functionalities to provide certain personalized services, which may require any user accessing the services to authenticate to the server before the access. A web server may also include one or more processors to execute computer programs in parallel.

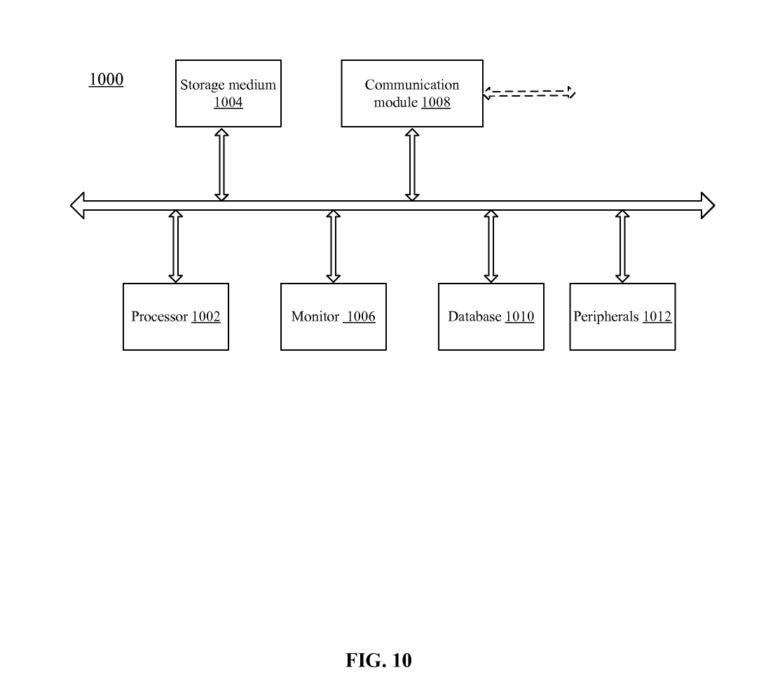

Client 901 and/or server 902 may be implemented on any appropriate computing platform. As shown in FIG. 10, computer system 1000 may include a processor 1002, a storage medium 1004, a monitor 1006, a communication module 1008, a database 1010, and peripherals 1012. Certain devices may be omitted and other devices may be included.

Processor 1002 may include any appropriate processor or processors. Further, processor 1002 can include multiple cores for multi-thread or parallel processing. Storage medium 1004 may include memory modules, such as ROM, RAM, flash memory modules, and erasable and rewritable memory, and mass storages, such as CD-ROM, U-disk, and hard disk, etc. Storage medium 1004 may store computer programs for implementing various processes, when executed by processor 1002.

Further, peripherals 1012 may include I/O devices such as keyboard and mouse, and communication module 1008 may include network devices for establishing connections through the communication network. Database 1010 may include one or more databases for storing certain data and for performing certain operations on the stored data, such as database searching.

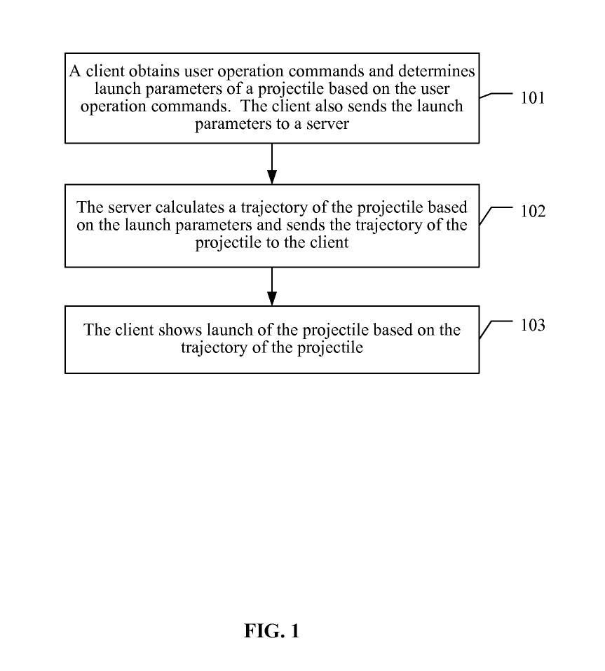

In operation, client 901 and server 902 may interact with each other to provide enhanced online gaming services to the user(s) of client 901. FIG. 1 illustrates a flow diagram of an exemplary anti-cheating method for online games consistent with the disclosed embodiments.

As shown in FIG. 1, the method includes the following steps:

Step 101: the client obtains user operation commands, determines launch parameters of the projectile based on the user operation commands, and sends the launch parameters to the server.

In a variety of online games, game operations often involve launching objects. For example, tanks fire bombs; aircrafts fire missiles; the game actors fire bullets. The game operations are related to the launch process of the projectiles.

The online games that are related to launching projectiles may include both Player vs Player (PvP) games and Player vs Environment (PvE) games. PvP game is a type of multiplayer interactive game between two or more live participants; while PvE game is a game that a player competes against a computer-controlled non-player character (NPC), such as monsters, boss, etc.

At the beginning, the client first obtains the user operation commands. Then, the client determines the launch parameters of the projectile based on the user operation commands.

The client may set in advance corresponding relationships between the operation commands and the launch parameters. Then, the client the client determines the launch parameters of the projectile by obtaining the user operation commands. For example, the user operation commands may include: the user presses a preset specific key; the user presses a mouse; the user presses a key for a predefined time period; the user clicks a mouse for a predefined time period; joystick operations, and so on.

The launch parameters may further include: launch angle of the projectile, launch force of the projectile, initial launch velocity of the projectile, etc. The client determines the launch parameters of the projectile based on the user operation commands and sends the launch parameters to the server.

Step 102: the server calculates the trajectory of the projectile based on the launch parameters and sends the trajectory of the projectile to the client.

The trajectory of the projectile may be calculated by the real physical integral formulas. Calculation principles may include: calculating forces involved in projectile motion; setting initial state of the projectile; calculating trajectory coordinates of the projectile by integration based on the initial state and the forces involved in projectile motion, etc.

The calculation process further includes:

Calculation step 1: calculating various forces involved in projectile motion.

In the real world, a flying projectile is influenced by air resistance, wind force, gravity, etc. In online games, the forces may be simulated. For example, air resistance may be calculated based on a preset air resistance coefficient of a scene and a preset air resistance coefficient of the projectile; wind force may be calculated based on a preset wind force of a scene and a preset wind resistance coefficient of the projectile; acceleration of gravity may be calculated based on a preset acceleration of gravity of a scene and a preset acceleration of gravity coefficient of the projectile; the gravity of the projectile may be calculated based on a preset mass of the projectile and the calculated acceleration of gravity, etc.

For example, calculation of these forces may be performed as follows:

AirForce=SceneAirResistance*BombAirResitFactor (1)

where AirForce is air resistance; SceneAirResistance is an air resistance coefficient of a scene; and BombAirResitFactor is an air resistance coefficient of a projectile.

WindForce=SceneWind*BombWindFactor (2)

where WindForce is wind force; SceneWind is wind force of a scene; and BombWindFactor is a wind resistance coefficient of a projectile.

G=SceneGravity*BombGravityFactor (3)

where G is the acceleration of gravity; SceneGravity is the acceleration of gravity of a scene; and BombGravityFactor is the acceleration of gravity coefficient of a projectile.

WeightForce=G*BombMass (4)

where WeightForce is the gravity of a projectile; G is the acceleration of gravity; and BombMass is the mass of a projectile.

By changing each parameter in the above formulas, various forces acting on the projectile during the flight may be adjusted, thus affecting the trajectory of the projectile.

Calculation step 2: setting initial state of the projectile, such as initial position and/or initial velocity of the projectile.

(Xo, Yo): the initial position of the projectile, that is, the position at which the player launches the projectile;

(Vx, Vy): the initial velocity (a vector) of the projectile, that is, initial flight direction and speed of the projectile.

Calculation step 3: based on the initial state of the projectile and the influence of external forces, trajectory coordinates of the projectile are calculated repeatedly by integration operation, where fixed length of integration interval is dt; each new velocity and coordinate of the projectile are calculated based on the previous velocity and coordinate. More specifically:

Ax=(WindForce−AirForce*Vx)/BombMass (5)

where Ax is X-axis acceleration of the projectile;

Vx=Vx+Ax*dt (6)

where Vx is X-axis velocity of the projectile;

X=X+Vx*dt (7)

where X is X-axis coordinate of the projectile;

Ay=(WeightForce−AirForce*Vy)/BombMass (8)

where Ay is Y-axis acceleration of the projectile;

Vy=Vy+Ay*dt (9)

where Vy is Y-axis velocity of the projectile;

Y=Y+Vy*dt (10)

where Y is Y-axis coordinate of the projectile.

After performing each integration calculation, based on the obtained coordinate (X, Y) of the projectile, the server judges whether the corresponding bit value on the terrain map is 1. Based on the judgment, the server then determines whether the projectile collides with the terrain. If the projectile collides with the terrain, the integration calculation process is stopped; otherwise, the next integration calculation is performed. During integration calculation process, the smaller the value of dt is, the more accurate the calculation result of the trajectory of the projectile is, but more CPU resources are consumed.

Based on the above calculation results, the coordinates of the trajectory of the projectile are obtained. The server sends the obtained coordinates of the trajectory of the projectile to the client.

Step 103: the client shows launch of the projectile based on the trajectory of the projectile.

After the client receives the coordinates of the trajectory of the projectile from the server, the client shows a specific picture for the motion of the projectile based on the coordinates of the trajectory of the projectile.

In some online games, the projectile has an impact on the terrain. For example, launched tank bombs blasts holes in the ground; and launched aircraft missiles blast holes in the hill. Thus, the projectile also has an impact on the game terrain of the game map after the collision.

Terrain data in battle games may be prestored on the server. The terrain data may be called from the memory when needed. When the terrain data in the battle games are stored in the memory, each pixel of the game map as a bit is stored in the memory. For example, the pixel that has a terrain may be set to 1; and the pixel that has no terrain may be set to 0. The data represented by 0 and 1 are arranged by the bits. Then, the arranged data may be stored in the bytes of the memory. In practice, the data are calculated based on each pixel.

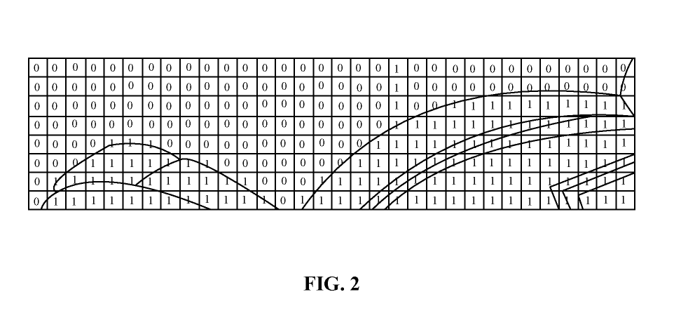

FIG. 2 illustrates a schematic diagram of an exemplary online game map that is divided into numerous terrain squares consistent with the disclosed embodiments. As shown in FIG. 2, a game map may be divided into numerous terrain squares, where the square that has a terrain may be stored as 1; the square that has no terrain may be stored as 0.

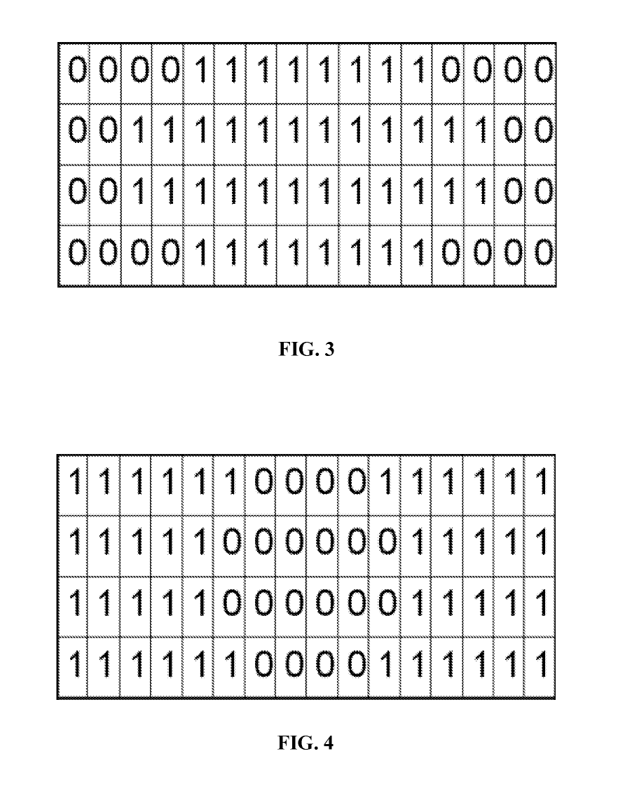

Based on the terrain shown in FIG. 2, FIG. 3 illustrates a data storage diagram of an exemplary online game map consistent with the disclosed embodiments. As shown in FIG. 3, the values of the terrain data stored on the server are: (0x0FF0, 0x3FFC, 0x3FFC, 0x0FF0).

The hole map data of the projectile in the battle game may also be prestored on the server. The data may be called from the memory when needed. The hole map data of the projectile is used to deduct or fill the terrain data when the projectile impacts the terrain, so as to achieve the purpose of destroying the terrain or filling the terrain.

The storage implementation for the hole map data of the projectile is similar to the storage implementation for the terrain data. Each pixel of the hole map of the projectile may be represented by 0 or 1. The hole map data of the projectile are stored in the memory through a sequence of bytes with each bit representing different meaning. For example, 1 represents the terrain that needs not to be hollowed, and 0 represents the terrain that needs to be hollowed.

FIG. 4 illustrates a data storage diagram of an exemplary hole map of the projectile consistent with the disclosed embodiments. As shown in FIG. 4, the hole map is a destructive hole map that is hollowed out 20 pixels in the middle. The values of the hole map data of the projectile stored on the server are: (0xFC3F, 0xF81F, 0xF81F, 0xFC3F).

The terrain data of online games arranged by the bits and the hole map data of the projectile arranged by the bits are stored on the server. Further, the server calculates terrain impact parameters of the projectile for the terrain based on the terrain data of online games and the hole map data of the projectile, and sends the terrain impact parameters to the client. The client further shows the effects of the projectile on the terrain based on the terrain impact parameters.

The terrain impact parameters represent the effects of the projectile on the terrain. The effects generally include: the destruction of the terrain (for example, the projectile causes a hole in the ground after explosion) and the fill of the terrain (for example, after the projectile collides on the ground, a piece of the terrain is filled out in the ground).

When the effects of the projectile is the destruction of the terrain, each pixel of the game map as a bit is stored on the server, where the pixel that has a terrain may be set to 1; and the pixel that has no terrain may be set to 0. The hole map data of the projectile arranged by the bits are stored on the server, where the bit representing the terrain that needs to be hollowed may be set to 0, and the bit representing the terrain that needs not to be hollowed may be set to 1. Then, the server performs a logical bitwise AND operation for the terrain data of the online game and the hole map data of the projectile to obtain the terrain impact parameters.

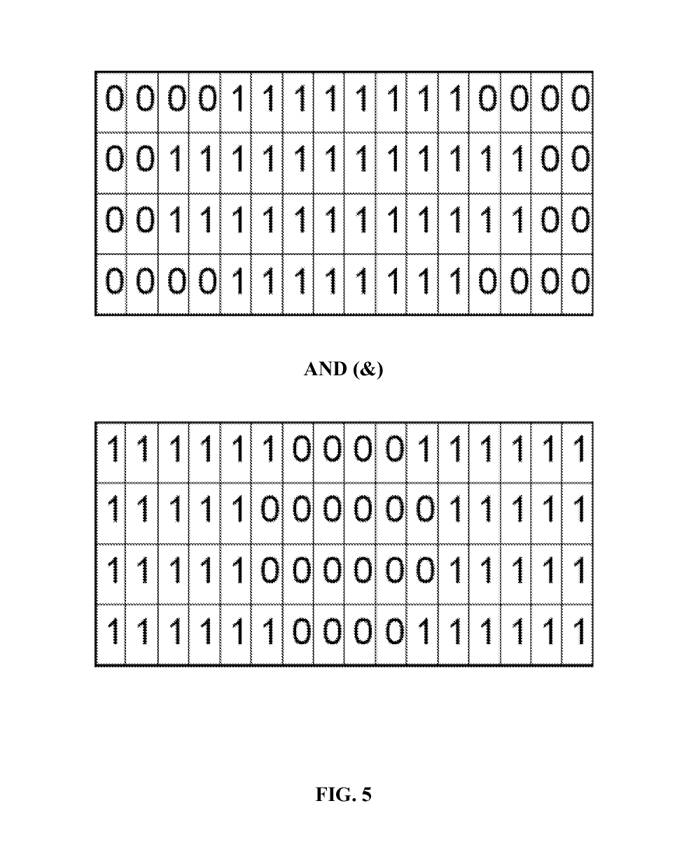

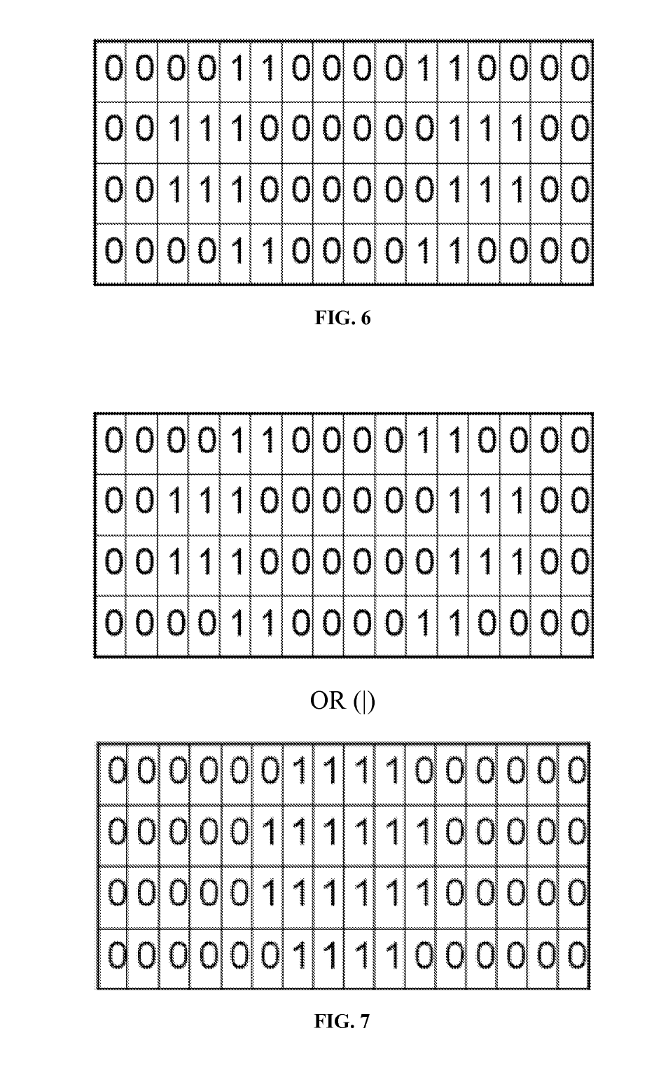

FIG. 5 illustrates a schematic diagram of an exemplary AND operation for the terrain data of online games and the hole map data of the projectile consistent with the disclosed embodiments. FIG. 6 illustrates a schematic diagram of an exemplary AND operation result for the terrain data of online games and the hole map data of the projectile consistent with the disclosed embodiments.

As shown in FIG. 5 and FIG. 6, the inputs are (0x0FF0, 0x3FFC, 0x3FFC, 0x0FF0), (0xFC3F, 0xF81F, 0xF81F, 0xFC3F), respectively. After performing a bitwise AND operation, the result is (0x0C30, 0x381C, 0x381C, 0x0C30). That is, the result is the terrain that is hollowed out 20 pixels in the middle.

When the effects of the projectile is the fill of the terrain, each pixel of the game map as a bit is stored on the server, where the pixel that has a terrain may be set to 1; and the pixel that has no terrain may be set to 0. The hole map data of the projectile arranged by the bits are stored on the server, where the bit represents the terrain that needs to be filled may be set to 1, and the bits represents the terrain that needs not to be filled may be set to 0. Then, the server performs a logical bitwise OR operation for the terrain data of the online game and the hole map data of the projectile to obtain the terrain impact parameters.

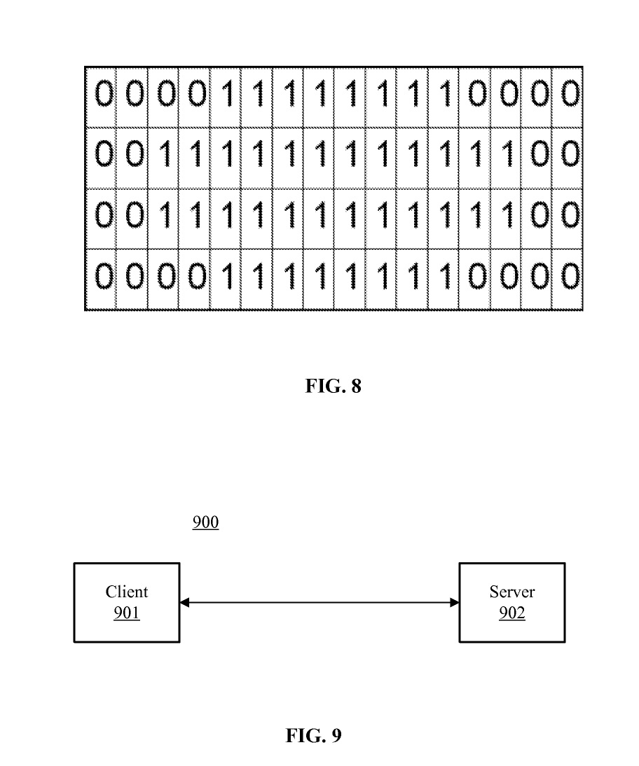

FIG. 7 illustrates a schematic diagram of an exemplary OR operation for terrain data and hole map data of the projectile consistent with the disclosed embodiments. FIG. 8 illustrates a schematic diagram of an exemplary OR operation result for terrain data and hole map data of the projectile consistent with the disclosed embodiments.

As shown in FIG. 7 and FIG. 8, the inputs are (0x0C30, 0x381C, 0x381C, 0x0C30), (0x03C0, 0x07E0, 0x07E0, 0x0C30), respectively. After performing a logical OR operation, the holes in a terrain are filled in.

The above specific bit values and logic operations for damaging and filling the terrain are only exemplary descriptions. The skilled in the art can understand that the above described embodiments are merely specific embodiments of the present invention, and the protection scope of the present invention is not limited thereto. In practice, some modification for bit values and logic operations may obtain the similar effect, as any modification or substitution easily conceivable to persons skilled in the art within the technical scope disclosed in the present invention shall be covered by the protection scope of the present invention.

Return to FIG. 9, game system 900 may implement an exemplary anti-cheating system for online games consistent with the disclosed embodiments. As shown in FIG. 9, the online game anti-cheating system includes client 901 and server 902.

The client 901 (e.g., processor 1002 of client 901) is configured to obtain user operation commands and determine launch parameters of the projectile based on the user operation commands. The client 901 is also configured to send the launch parameters to the server and present the launch of the projectile to the user based on the trajectory of the projectile.

The server 902 (e.g., processor 1002 of server 902) is configured to calculate the trajectory of the projectile based on the launch parameters and send the trajectory of the projectile to the client.

More specifically, the server 902 is configured to store the terrain data of online game arranged by the bits and the hole map data of the projectile arranged by the bits, to calculate terrain impact parameters of the projectile on the terrain based on the terrain data of online game and the hole map data of the projectile, and to send the terrain impact parameters to the client.

After receiving the terrain impact parameters from the server 902, the client 901 further presents to the user with the effects of the projectile on the terrain based on the terrain impact parameters.

In certain embodiments, the terrain data and the hole map data, along other data, may be stored on server 902 in any appropriate ways. For example, the server 902 may store each pixel of the game map as a bit, where the pixel that has a terrain may be set to 1 and the pixel that has no terrain may be set to 0. The server 902 may store hole map data of the projectile arranged by the bits, where the bits representing the terrain that needs to be hollowed may be set to 0, and the bits representing the terrain that needs not to be hollowed may be set to 1. Further, to obtain the terrain impact parameters, the server 902 may perform a logical bitwise AND operation for the terrain data of the online game and the hole map data of the projectile. The client 901 can then show the deduction effects of the projectile on the terrain based on the terrain impact parameters

In certain other embodiments, the server 902 may store each pixel of the game map as a bit, where the pixel that has a terrain may be set to 1; and the pixel that has no terrain may be set to 0. The server 902 may store the hole map data of the projectile arranged by the bits, where the bit representing the terrain that needs to be filled may be set to 1, and the bit representing the terrain that needs not to be filled may be set to 0. Further, to obtain the terrain impact parameters, the server 902 may perform a logical bitwise OR operation for the terrain data of the online game and the hole map data of the projectile. The client 901 can then show the filling effects of the projectile on the terrain based on the terrain impact parameters.

In certain embodiments, the server 902 may calculate forces involved in the projectile motion; set initial state of the projectile; and calculate trajectory coordinates of the projectile by integration operation based on the initial state of the projectile and forces involved in the projectile motion.

More specifically, the server 902 may calculate an air resistance based on a preset air resistance coefficient of a scene and a preset air resistance coefficient of the projectile; calculate wind force based on a preset wind force of a scene and a preset wind resistance coefficient of the projectile; calculate acceleration of gravity based on a preset acceleration of gravity of a scene and a preset acceleration of gravity coefficient of the projectile; and calculate gravity of the projectile based on a preset mass of the projectile and the calculated acceleration of gravity, etc.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems on any online application, the client obtains user operation commands, determines launch parameters of the projectile based on the user operation commands, and sends the launch parameters to the server; and the server calculates the trajectory of the projectile based on the launch parameters and sends the trajectory of the projectile to the client. The client can then show launch of the projectile based on the trajectory of the projectile. Thus, the server performs key logical operations and sends the operation results to the client. The client only shows the results rather than performs the key logical operations. Therefore, plug-in can be prevented, and the fairness of the game can be improved.

In addition, because the sever calculates the terrain impact parameters and the coordinates of the projectile, computing consumption of the client computer can be reduce and the speed of online games can be further increased.

What is claimed is:

1. An anti-cheating method for online games between a server and a client, comprising:
receiving, by the server, launch parameters of a projectile from the client, wherein the launch parameters are determined based on the user operation commands from the client;
calculating, by the server, a trajectory of the projectile based on the launch parameters; and
sending, by the server, the trajectory of the projectile to the client such that the client shows launch of the projectile based on the trajectory of the projectile.

2. The method according to claim 1, further including:
storing, by the server, terrain data of a game map arranged by bits and hole map data of the projectile arranged by bits;
calculating, by the server, terrain impact parameters of the projectile based on the terrain data of the game map and the hole map data of the projectile; and
sending, by the server, the terrain impact parameters to the client such that the client shows effects of the projectile on the terrain based on the terrain impact parameters.

3. The method according to claim 2, wherein storing terrain data of a game map arranged by bits and hole map data of the projectile arranged by bits further includes:
storing, by the server, each pixel of the game map as a bit, wherein the pixel that has a terrain is set to 1, and the pixel that has no terrain is set to 0;
storing, by the server, the hole map data of the projectile arranged by the bits, wherein the bit representing the terrain that needs to be hollowed is set to 0, and the bit representing the terrain that needs not to be hollowed is set to 1; and
calculating, by the server, the terrain impact parameters of the projectile based on the terrain data of the game map and the hole map data of the projectile by performing a logical bitwise AND operation for the terrain data of the game map and the hole map data of the projectile.

4. The method according to claim 2, wherein storing terrain data of a game map arranged by bits and hole map data of the projectile arranged by bits further includes:
storing, by the server, each pixel of the game map as a bit, wherein the pixel that has a terrain is set to 1, and the pixel that has no terrain is set to 0;
storing, by the server, the hole map data of the projectile arranged by the bits, wherein the bit representing the terrain that needs to be filled is set to 1, and the bit representing the terrain that needs not to be filled is set to 0; and
calculating, by the server, the terrain impact parameters of the projectile based on the terrain data of the game map and the hole map data of the projectile by performing a logical bitwise OR operation for the terrain data of the game map and the hole map data of the projectile.

5. The method according to claim 1, wherein calculating the trajectory of the projectile based on the launch parameters further includes:
calculating forces involved in the projectile motion;
setting an initial state of the projectile; and
calculating trajectory coordinates of the projectile by integration based on the initial state and the forces involved in the projectile motion.

6. The method according to claim 5, wherein calculating forces involved in the projectile motion further includes:
calculating air resistance based on a preset air resistance coefficient of a scene and a preset air resistance coefficient of the projectile;
calculating wind force based on a preset wind force of a scene and a preset wind resistance coefficient of the projectile;
calculating acceleration of gravity based on a preset acceleration of gravity of a scene and a preset acceleration of gravity coefficient of the projectile; and
calculating the gravity of the projectile based on a preset mass of the projectile and the calculated acceleration of gravity.

7. An anti-cheating system for online games, comprising:
a client and a server connecting the client through the Internet, wherein:
the client is configured to:
obtain user operation commands;
determine launch parameters of a projectile based on the user operation commands;
send the launch parameters to the server; and
show the launch of the projectile based on a trajectory of the projectile; and
the server is configured to:
calculate the trajectory of the projectile based on the launch parameters; and
send the trajectory of the projectile to the client.

8. The system according to claim 7, wherein the server is further configured to:
store the terrain data of a game map arranged by bits and hole map data of the projectile arranged by bits;
calculate terrain impact parameters of the projectile on the terrain based on the terrain data of the game map and the hole map data of the projectile; and
send the terrain impact parameters to the client; and
wherein the client is further configured to show effects of the projectile on the terrain based on the terrain impact parameters.

9. The system according to claim 8, wherein the server is further configured to:
store each pixel of the game map as a bit, where the pixel that has a terrain may be set to 1, and the pixel that has no terrain may be set to 0;
store the hole map data arranged by the bits of the projectile, where the bit representing the terrain that needs to be hollowed is set to 0, and the bit representing the terrain that needs not to be hollowed is set to 1; and
perform a logical bitwise AND operation for the terrain data of the game map and the hole map data of the projectile to obtain the terrain impact parameters; and
wherein the client is configured to show the effects of the projectile on deducting the terrain based on the terrain impact parameters.

10. The system according to claim 8, wherein the server is further configured to:
store each pixel of the game map as a bit, where the pixel that has a terrain is set to 1, and the pixel that has no terrain is set to 0;
store the hole map data of the projectile arranged by the bits, where the bit representing the terrain that needs to be filled is set to 1, and the bit representing the terrain that needs not to be filled is set to 0; and
perform a logical bitwise OR operation for the terrain data of the game map and the hole map data of the projectile to obtain the terrain impact parameters; and
wherein the client is further configured to show the effects of the projectile on filling the terrain based on the terrain impact parameters.

11. The system according to claim 7, wherein the server is further configured to:
calculate forces involved in projectile motion;
set an initial state of the projectile; and
calculate trajectory coordinates of the projectile by integration based on the initial state and the forces involved in projectile motion.

12. The system according to claim 11, wherein the server is further configured to:
calculate air resistance based on a preset air resistance coefficient of a scene and a preset air resistance coefficient of the projectile;
calculate wind force based on a preset wind force of a scene and a preset wind resistance coefficient of the projectile;
calculate acceleration of gravity based on a preset acceleration of gravity of a scene and a preset acceleration of gravity coefficient of the projectile; and
calculate gravity of the projectile based on a preset mass of the projectile and the calculated acceleration of gravity.
